(19) United States
(12) Patent Application Publication
(10) Pub. No.: US 2026/0246923 A1
(43) Pub. Date: Aug. 20, 2026

(54) Methods and Apparatus for Hiding Bias Term of Cross-Component Prediction Model in Video Coding

(71) Applicant: MEDIATEK INC., Hsinchu City (TW)

(72) Inventors: Hsin-Yi TSENG, Hsinchu City (TW); Cheng-Yen CHUANG, Hsinchu City (TW); Chia-Ming TSAI, Hsinchu City (TW); Chih-Wei HSU, Hsinchu City (TW); Yi-Wen CHEN, San Jose, CA (US); Tzu-Der CHUANG, Hsinchu City (TW); Ching-Yeh CHEN, Hsinchu City (TW)

(21) Appl. No.: 19/161,460

(22) PCT Filed: Mar. 20, 2024
(86) PCT No.: PCT/CN2024/082664

§ 371 Date: Sep. 2, 2025

Related U.S. Application Data
(60) Provisional application No. 63/491,088, filed on Mar. 20, 2023.

(51) Int. Cl. H04N 19/107; H04N 19/132; H04N 19/136; H04N 19/176; H04N 19/186

(52) U.S. Cl. CPC H04N 19/107; H04N 19/132; H04N 19/136; H04N 19/176; H04N 19/186

(57) ABSTRACT

A method and apparatus for video coding using coding tools including one or more cross component models related modes. According to one method, one or more offset values for one or more of n input terms associated with a CCP (Cross-Component Prediction) model are derived. A derived adjusted bias term corresponding to a combination of a weighted bias term, and one or more weighted offset values associated with said one or more of the n input terms is derived. A derived adjusted bias term parameter associated with the derived adjusted bias term is derived accordingly. A CCP is generated using a CCP model including the derived adjusted bias term parameter for encoding or decoding. According to another method, a candidate list including a partially inherited CCP candidate is used.

### CROSS REFERENCE TO RELATED APPLICATIONS

The present invention is a non-Provisional application of and claims priority to U.S. Provisional Patent Application No. 63/491,088, filed on Mar. 20, 2023. The U.S. Provisional patent application is hereby incorporated by reference in its entirety.

### FIELD OF THE INVENTION

The present invention relates to video coding system using cross-component prediction modes. In particular, the present invention relates to the cross-component prediction mode using an adjusted bias term parameter or a partially inherited CCP candidate.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Some new tools relevant to the present invention are reviewed as follows.

### Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i, j) represents the predicted chroma samples in a CU and rec_{L}′(i, j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when CCLM_LT mode is applied;
W′=W+H when CCLM_T mode is applied;
H′=H+W when CCLM_L mode is applied.

The above neighbouring positions are denoted as S[0, −1] . . . S[W′−1, −1] and the left neighbouring positions are denoted as S[−1, 0] . . . S[−1, H′−1]. Then the four samples are selected as
S[W′/4, −1], S[3*W′/4, −1], S[−1, H′/4], S[−1, 3*H′/4] when CCLM_LT mode is applied and both above and left neighbouring samples are available;
S[W′/8, −1], S[3*W′/8, −1], S[5*W′/8, −1], S[7*W′/8, −1] when CCLM_T mode is applied or only the above neighbouring samples are available;
S[−1, H′/8], S[−1, 3*H′/8], S[−1, 5*H′/8], S[−1, 7*H′/8] when CCLM_L mode is applied or only the left neighbouring samples are available.

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$${x}_{A} = ( {x}_{A}^{0} + {x}_{A}^{1} + 1 ) >> 1 ; \qquad ( 2 )$$

$${x}_{B} = ( {x}_{B}^{0} + {x}_{B}^{1} + 1 ) >> 1 ;$$

$${y}_{A} = ( {y}_{A}^{0} + {y}_{A}^{1} + 1 ) >> 1 ;$$

$${y}_{B} = ( {y}_{B}^{0} + {y}_{B}^{1} + 1 ) >> 1$$

Finally, the linear model parameters α and β are obtained according to the following equations.

$$α = \frac{{y}_{A} - {y}_{B}}{{x}_{A} - {x}_{B}} \qquad ( 3 )$$

$$β = {Y}_{b} - α \cdot {X}_{b} \qquad ( 4 )$$

FIG. 2 shows an example of the location of the left and above samples and the sample of the current block involved in the CCLM_LT mode. FIG. 2 shows the relative sample locations of N×N chroma block 210, the corresponding 2N×2N luma block 220 and their neighbouring samples (shown as filled circles).

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables.

Besides the above template and left template can be used to calculate the linear model coefficients together, they also can be used alternatively in the other 2 LM modes, called CCLM_T, and CCLM_L modes.

In CCLM_T mode, only the above template is used to calculate the linear model coefficients. To get more samples, the above template is extended to (W+H) samples. In CCLM_L mode, only left template are used to calculate the linear model coefficients. To get more samples, the left template is extended to (H+W) samples.

In CCLM_LT mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ r e {c}_{L} ( 2 i - 1 , 2 j - 1 ) + 2 \cdot {rec}_{L} ( 2 i , 2 j - 1 ) + {rec}_{L} ( 2 i + 1 , 2 j - 1 ) + re {c}_{L} ( 2 i - 1 , 2 j ) + 2 \cdot {rec}_{L} ( 2 i , 2 j ) + r e {c}_{L} ( 2 i + 1 , 2 j ) + 4 ] >> 3 \qquad ( 6 )$$

$${Rec}_{L}^{′} ( i , j ) = r e {c}_{L} ( 2 i , 2 j - 1 ) + r e {c}_{L} ( 2 i - 1 , 2 j ) + 4 \cdot {rec}_{L} ( 2 i , 2 j ) + re {c}_{L} ( 2 i + 1 , 2 j ) + re {c}_{L} ( 2 i , 2 j + 1 ) + 4 ] >> 3 \qquad ( 7 )$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the a and 0 values to the decoder.

For chroma intra mode coding, a total of 8 intra modes are allowed for chroma intra mode coding. Those modes include five traditional intra modes and three cross-component linear model modes (CCLM_LT, CCLM_T, and CCLM_L). Chroma mode signalling and derivation process are shown in Table 1. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the centre position of the current chroma block is directly inherited.

TABLE 1
Derivation of chroma prediction mode
from luma mode when CCLM is enabled

| | Corresponding luma intra prediction mode | | | | |
|---|---|---|---|---|---|
| Chroma prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2.

TABLE 2
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2, the first bin indicates whether it is regular (0) or CCLM modes (1). If it is CCLM mode, then the next bin indicates whether it is CCLM_LT (0) or not. If it is not CCLM_LT, next 1 bin indicates whether it is CCLM_L (0) or CCLM_T (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular a and f are derived for a particular group). Furthermore, the samples of the current luma block are also classified based on the same rule for the classification of neighbouring luma samples. Three MMLM model modes (MMLM_LT, MMLM_T, and MMLM_L) are allowed for choosing the neighbouring samples from left-side and above-side, above-side only, and left-side only, respectively.

FIG. 3 shows an example of classifying the neighbouring samples into two groups. Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}Pre {d}_{C} [ x , y ] = {α}_{1} \times {Rec}_{L}^{′} [ x , y ] + {β}_{1} & if {Rec}_{L}^{′} [ x , y ] \leq Threshold \\ Pre {d}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 8 )$$

Accordingly, the MMLM uses two models according to the sample level of the neighbouring samples.

### Slope Adjustment of CCLM

CCLM uses a model with 2 parameters to map luma values to chroma values as shown in FIG. 4A. The slope parameter “a” and the bias parameter “b” define the mapping as follows:

$$chromaVal = a * lumaVal + b$$

An adjustment “u” to the slope parameter is signalled to update the model to the following form, as shown in FIG. 4B:

$$chromaVal = {a}^{′} * lumaVal + {b}^{′}$$

$$where$$

$${a}^{′} = a + u ,$$

$${b}^{′} = b - u * {y}_{r} .$$

With this selection, the mapping function is tilted or rotated around the point with luminance value yr. The average of the reference luma samples used in the model creation as yr in order to provide a meaningful modification to the model. FIG. 4A and FIG. 4B illustrates the process.

### Implementation of Slope Adjustment of CCLM

Slope adjustment parameter is provided as an integer between −4 and 4, inclusive, and signalled in the bitstream. The unit of the slope adjustment parameter is (⅛)-th of a chroma sample value per luma sample value (for 10-bit content).

Adjustment is available for the CCLM models that are using reference samples both above and left of the block (e.g. “LM_CHROMA_IDX” and “MMLM_CHROMA_IDX”), but not for the “single side” modes. This selection is based on coding efficiency versus complexity trade-off considerations. “LM_CHROMA_IDX” and “MMLM_CHROMA_IDX” refers to CCLM_LT and MMLM_LT in this invention. The “single side” modes refer to CCLM_L, CCLM_T, MMLM_L, and MMLM_T in this invention.

When slope adjustment is applied for a multimode CCLM model, both models can be adjusted and thus up to two slope updates are signalled for a single chroma block.

### Encoder Approach for Slope Adjustment of CCLM

The proposed encoder approach performs an SATD (Sum of Absolute Transformed Differences) based search for the best value of the slope update for Cr and a similar SATD based search for Cb. If either one results as a non-zero slope adjustment parameter, the combined slope adjustment pair (SATD based update for Cr, SATD based update for Cb) is included in the list of RD (Rate-Distortion) checks for the TU.

### Convolutional Cross-Component Model (CCCM)

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

The convolutional model has 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south (S), left/west (W) and right/east (E) neighbours as shown in FIG. 5.

The nonlinear term (denoted as P) is represented as power of two of the centre luma sample C and scaled to the sample value range of the content:

$$P = ( C * C + midVal ) >> bitDepth .$$

For example, for 10-bit contents, the nonlinear term is calculated as:

$$P = ( C * C + 5 \; 12 ) >> 10$$

The bias term (denoted as B) represents a scalar offset between the input and output (similarly to the offset term in CCLM) and is set to the middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

The filter coefficients cᵢ are calculated by minimising MSE between predicted and reconstructed chroma samples in the reference area. FIG. 6 illustrates an example of the reference area which consists of 6 lines of chroma samples above and left of the PU. Reference area extends one PU width to the right and one PU height below the PU boundaries. Area is adjusted to include only available samples. The extensions to the area (indicated as “paddings”) are needed to support the “side samples” of the plus-shaped spatial filter in FIG. 5 and are padded when in unavailable areas.

The MSE minimization is performed by calculating autocorrelation matrix for the luma input and a cross-correlation vector between the luma input and chroma output. There are various known methods to solve the MSE minimization problem. For example, autocorrelation matrix can be LDL decomposed and the final filter coefficients are calculated using back-substitution. The process follows roughly the calculation of the ALF filter coefficients in ECM (Enhanced Compression Model) for the emerging video coding standard development, however LDL decomposition was chosen instead of Cholesky decomposition to avoid using square root operations. The MSE minimization problem can also be solved using Gaussian elimination.

### Gradient Linear Model (GLM)

For YUV 4:2:0 colour format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

For signalling, when the CCLM mode is enabled for the current CU, one flag is signalled to indicate whether GLM is enabled for both Cb and Cr components; if the GLM is enabled, another flag is signalled to indicate which of the two GLM modes is selected and one syntax element is further signalled to select one of 4 gradient filters (710-740 in FIG. 7) for the gradient calculation.

### Bitstream Signalling

Usage of the mode is signalled with a CABAC coded PU level flag. One new CABAC context is included to support this. When it comes to signalling, CCCM is considered a sub-mode of CCLM. That is, the CCCM flag is only signalled if intra prediction mode is LM_CHROMA.

### Spatial Candidate Derivation

The derivation of spatial merge candidates in VVC is the same as that in HEVC except that the positions of first two merge candidates are swapped. A maximum of four merge candidates (B₀, A₀, B₁ and A₁) for current CU 810 are selected among candidates located in the positions depicted in FIG. 8. The order of derivation is B₀, A₀, B₁, A₁ and B₂. Position B₂ is considered only when one or more neighbouring CU of positions B₀, A₀, B₁, A₁ are not available (e.g. belonging to another slice or tile) or is intra coded. After candidate at position A₁ is added, the addition of the remaining candidates is subject to a redundancy check which ensures that candidates with the same motion information are excluded from the list so that coding efficiency is improved. To reduce computational complexity, not all possible candidate pairs are considered in the mentioned redundancy check. Instead, only the pairs linked with an arrow in FIG. 9 are considered and a candidate is only added to the list if the corresponding candidate used for redundancy check does not have the same motion information.

### Temporal Candidates Derivation

In this step, only one candidate is added to the list. Particularly, in the derivation of this temporal merge candidate for a current CU 1010, a scaled motion vector is derived based on the co-located CU 1020 belonging to the collocated reference picture as shown in FIG. 10. The reference picture list and the reference index to be used for the derivation of the co-located CU is explicitly signalled in the slice header. The scaled motion vector 1030 for the temporal merge candidate is obtained as illustrated by the dotted line in FIG. 10, which is scaled from the motion vector 1040 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 11 If CU at position C₀ is not available, is intra coded, or is outside of the current row of CTUs, position C₁ is used. Otherwise, position C₀ is used in the derivation of the temporal merge candidate.

### Non-Adjacent Spatial Candidate

During the development of the VVC standard, a coding tool referred as Non-Adjacent Motion Vector Prediction (NAMVP) has been proposed in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399). According to the NAMVP technique, the non-adjacent spatial merge candidates are inserted after the TMVP (i.e., the temporal MVP) in the regular merge candidate list. The pattern of spatial merge candidates is shown in FIG. 12. The distances between non-adjacent spatial candidates and current coding block are based on the width and height of current coding block. In FIG. 12, each small square corresponds to a NAMVP candidate and the candidates are ordered (as shown by the number inside the square) according to the distance. The line buffer restriction is not applied. In other words, the NAMVP candidates far away from a current block may have to be stored that may require a large buffer.

In the present invention, methods and apparatus to improve the coding performance of cross-component prediction by using an adjusted bias term parameter or using a partially inherited cross-component prediction mode are disclosed.

### BRIEF SUMMARY OF THE INVENTION

A method and apparatus for video coding using coding tools including one or more cross component models related modes are disclosed. According to one method, input data associated with a current block comprising a first-colour block and a second-colour block are received, wherein the input data comprise coded data associated with the current block to be decoded at a decoder side. A stored adjusted bias term parameter is retrieved. One or more offset values for one or more of n input terms associated with a CCP (Cross-Component Prediction) model are determined, wherein each of said one or more offset values is determined for one of said one or more of the n input terms. A derived adjusted bias term corresponding to a combination of a weighted bias term, and one or more weighted offset values associated with said one or more of the n input terms is derived, and wherein the weighted bias term corresponds to a bias term weighted by the stored adjusted bias term parameter, and said one or more weighted offset values correspond to said one or more offset values weighted by one or more model parameters respectively. A derived adjusted bias term parameter associated with the derived adjusted bias term is determined, wherein the derived adjusted bias term corresponds to the bias term weighted by the derived adjusted bias term parameter. The second-colour block is decoded by using prediction candidates comprising a cross-component predictor generated by applying the CCP model comprising the derived adjusted bias term parameter to the first-colour block.

In one embodiment, the CCP model corresponds to Gradient and Location based Convolutional Cross-Component Model (GL-CCCM). In one embodiment, said one or more offset values comprise a horizontal offset value and a vertical offset value corresponding to offset values of a top-left location of the current block relative to a top-left location of neighbouring reference area, and wherein the neighbouring reference area is used to derive at least partial information related to the CCP model.

In one embodiment, all or part of said one or more offset values are determined based on information comprising neighbouring information. For example, the neighbouring information may comprise values of one or more neighbouring samples, availability of said one or more neighbouring samples, a total number of available reference lines, or a combination thereof. In one embodiment, if a target offset value is derived solely based on the neighbouring information, the target offset value is included in the derived adjusted bias term. In one embodiment, if a target offset value is not derived solely based on the neighbouring information, the target offset value is stored explicitly. In one embodiment, said one or more offset values correspond to one or more reference samples just outside a top-left corner of the current block.

A corresponding method for the encoder side is also disclosed. At the encoder side, input data associated with a current block comprising a first-colour block and a second-colour block are received, wherein the input data comprise pixel data associated with the current block to be encoded at an encoder side. Model parameters for a CCP (Cross-Component Prediction) model are derived, wherein the CCP model corresponds to a weighted sum of n input terms including a bias term and n is an integer greater than 1. One or more offset values for one or more of the n input terms are determined, wherein each of said one or more offset values is determined for one of said one or more of the n input terms. An adjusted weighted bias term is determined by combining a weighted bias term and said one or more offset values weighted by one or more model parameters respectively. An adjusted bias term parameter is determined, wherein the adjusted weighted bias term corresponds to the bias term scaled by the adjusted bias term parameter. The adjusted bias term parameter for processing of subsequent blocks is stored. The second-colour block is encoded by using prediction candidates comprising a cross-component predictor generated by applying the CCP model to the first-colour block.

A method and apparatus of CCP using a partially inherited CCP candidate. According to this method, a candidate list comprising at least one partially inherited CCP (Cross-Component prediction) candidate is derived, wherein partial parameters of said at least one partially inherited CCP candidate are inherited and remaining parameters of said at least one partially inherited CCP candidate are derived using neighbouring first-colour and second-colour samples. The second-colour block is encoded or decoded by using information comprising a predictor generated by applying a CCP model corresponding to said at least one partially inherited CCP candidate to the first-colour block.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows an example of the location of the left and above samples and the sample of the current block involved in the CCLM_LT mode.

FIG. 3 shows an example of classifying the neighbouring samples into two groups.

FIG. 4A illustrates an example of the CCLM model.

FIG. 4B illustrates an example of the effect of the slope adjustment parameter “u” for model update.

FIG. 5 illustrates an example of spatial part of the convolutional filter.

FIG. 6 illustrates an example of reference area with paddings used to derive the filter coefficients.

FIG. 7 illustrates the 4 gradient patterns for Gradient Linear Model (GLM).

FIG. 8 illustrates the neighbouring blocks used for deriving spatial merge candidates for VVC.

FIG. 9 illustrates the possible candidate pairs considered for redundancy check in VVC.

FIG. 10 illustrates an example of temporal candidate derivation, where a scaled motion vector is derived according to POC (Picture Order Count) distances.

FIG. 11 illustrate the positions for the temporal candidate selected between candidates C₀ and C₁.

FIG. 12 illustrates an exemplary pattern of the non-adjacent spatial merge candidates.

FIG. 13 illustrates an example of hiding the horizontal offset and the vertical offset of Gradient and Location based Convolutional Cross-Component Model (GL-CCCM) according to an embodiment of the present invention.

FIG. 14 illustrates a flowchart of an exemplary video decoding system that uses an adjusted bias term parameter according to an embodiment of the present invention.

FIG. 15 illustrates a flowchart of an exemplary video encoding system that uses an adjusted bias term parameter according to an embodiment of the present invention.

FIG. 16 illustrates a flowchart of an exemplary video coding system that uses a partially inherited Cross-Component Prediction (CCP) candidate according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The following methods are proposed to improve performance of video coding system using CCP (Cross-Component Prediction) model.

Removing Fixed Offsets from Luma and Chroma Samples

The autocorrelation matrix is calculated using the reconstructed values of luma and chroma samples. These samples are full range (e.g. between 0 and 1023 for 10-bit contents) resulting in relatively large values in the autocorrelation matrix. This requires high bit depth operations during the model parameters calculation. A method is disclosed in JVET-AB0174 (Alireza Aminlou, et al., “AHG12: Division-free operation and dynamic range reduction for convolutional cross-component model (CCCM)”, Joint Video Exploration Team (JVET) of ITU-TSG 16 WP 3 and ISO/IEC JTC 1/SC 29/WG 11, 28th Meeting, Mainz, DE, 20-28 Oct. 2022, Document: JVET-AB0174) to remove fixed offsets from luma and chroma samples in each PU for each model. This is to drive down the magnitudes of the values used in the model creation and allows reducing the precision needed for the fixed-point arithmetic. As a result, 16-bit decimal precision is used instead of the 22-bit precision of the original CCCM implementation.

Values of reference samples just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$${C}^{′} = C - offsetLuma ,$$

$${N}^{′} = N - offsetLuma ,$$

$${S}^{′} = S - offsetLuma ,$$

$${E}^{′} = E - offsetLuma ,$$

$${W}^{′} = W - offsetLuma ,$$

$${P}^{′} = nonLinear ( {C}^{′} ) ,$$

$$B - midValue = 1 << ( bitDepth - 1 ) ,$$

and the chroma value is predicted using the following equation, where offsetChroma is equal to offsetCr and offsetCb for Cr and Cb components, respectively:

$$predChromaVal = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation, the chroma offset is added to the bias term of the convolutional model.

The process of CCCM model parameter calculation requires division operations. Division operations are not always considered implementation friendly. The division operations are replaced with multiplications (with a scale factor) and shift operations, where the scale factor and number of shifts are calculated based on denominator similar to the method used in calculation of CCLM parameters.

### Gradient and Location Based Convolutional Cross-Component Model (GL-CCCM)

In JVET-AC0054 (Ramin G. Youvalari, et al., “EE2-1.12: Gradient and location based convolutional cross-component model (GL-CCCM) for intra prediction”, Joint Video Exploration Team (JVET) of ITU-TSG 16 WP 3 and ISO/IEC JTC 1/SC 29/WG 11, 29th Meeting, by teleconference, 11-20 Jan. 2023, Document: JVET-AC0054), a GL-CCCM method is disclosed, which uses gradient and location information instead of the 4 spatial neighbouring samples in the CCCM filter. The GL-CCCM filter for the prediction is:

$$predChromaVal = {c}_{0} C + {c}_{1} {G}_{y} + {c}_{2} {G}_{x} + {c}_{3} Y + {c}_{4} X + {c}_{5} P + {c}_{6} B ,$$

where G_{y} and Gₓ are the vertical and horizontal gradients, respectively, and are calculated as:

$${G}_{y} = ( 2 N + N W + N E ) - ( 2 S + S W + SE )$$

$${G}_{x} = ( 2 W + N W + S W ) - ( 2 E + N E + S E )$$

Moreover, the Y and X parameters are the vertical and horizontal locations of the centre luma sample.

The rest of the parameters are the same as the CCCM tool. The reference area for the parameter calculation is the same as CCCM method.

Usage of the mode is signalled with a CABAC coded PU level flag. One new CABAC context was included to support this. When it comes to signalling, GL-CCCM is considered a sub-mode of CCCM. That is, the GL-CCCM flag is only signalled if original CCCM flag is true.

### CCM Parameters Reduction Methods

The cross-component model (CCM) related information (e.g., model parameters, model type, template region . . . ) of previous coded blocks is stored in a buffer for the use of cross-component prediction (CCP) merge mode or other similar coding tools. CCP merge mode refers to tools that inherit CCP models from neighbouring blocks. In CCP merge mode, a candidate list is constructed by including various types of candidates, a candidate in the list is selected, and the prediction is generated based on the selected candidate. The types of candidates include, but not limited to, spatial candidates, temporal candidates, non-adjacent spatial candidates and history-based candidates. The spatial candidates correspond to CCM related information inherited from an immediate neighbouring block at pre-defined positions. For example, the pre-defined positions are the same as those of the spatial merge candidates in inter merge mode, as described in Section entitled “Spatial Candidate Derivation”. The temporal candidates are CCM related information inherited from pre-defined positions in previous coded pictures/slices. For example, the pre-defined positions and the previous coded picture are the same as those of the temporal merge candidates in inter merge mode, as described in Section entitled “Temporal Candidates Derivation”. The non-adjacent spatial candidates are CCM related information inherited from pre-defined positions that are not immediately next to the current block. For example, the pre-defined positions and the previous coded picture are the same as those of the non-adjacent spatial candidates in inter merge mode, as described in Section entitled “Non-Adjacent Spatial Candidate”. History-based candidates are candidates retrieved from a history list, which stores CCM related information of previous coded blocks.

The cross-component model (CCM) related information can include, but not limited to, prediction mode (e.g., CCLM, MMLM, CCCM, 2-parameter GLM, 3-parameter GLM), model index for indicating which model shape is used in the convolutional model, classification threshold for multi-model, information to indicate whether non-downsampled samples are used in the convolutional model, down-sampling filter flag, down-sampling filtering index when multiple down-sampling filters are used, number of neighbouring lines used to derive model, types of templates used to derive model, post-filtering flag and/or model parameters.

However, for the worst case, each 4×4 block needs to store one set of CCP information, which can be a huge implementation cost especially for the part of storing CCP model parameters. For example, the data type of CCCM parameter is 64-bit integer in ECM implementation. Therefore, some bit depth reduction methods for CCP parameters are proposed in this disclosure.

The bit depth reduction method can be applied to the integer part of CCP parameters or the fractional part of CCP parameters.

In one embodiment, a clipping operation can be used in the bit depth reduction method for the integer part of CCP parameters, and there can be one clipping threshold or multiple clipping thresholds. In one embodiment, the clipping threshold can be a pre-defined value, one of multiple pre-defined values in a lookup table, or an implicitly derived value.

In one embodiment, the clipping threshold can be the same for all CCP parameters. In another embodiment, the clipping threshold can be all different or partially different for each CCP parameter. In another embodiment, the clipping threshold can be all different or partially different for each parameter type (e.g., spatial term, gradient term, non-linear term, location term or bias term, etc.)

In one embodiment, a rounding operation can be used in the bit depth reduction method for the fractional part of CCP parameters. In another embodiment, a round up or round down operation can be used in the bit depth reduction method for the fractional part of CCP parameters.

In one embodiment, the rounding precision can be the same for all CCP parameters. In another embodiment, the rounding precision can be all different or partially different for each CCP parameter. In another embodiment, the rounding precision can be all different or partially different for each parameter type (e.g., spatial term, gradient term, non-linear term, location term or bias term . . . .)

In one embodiment, a pruning operation can be used in the bit depth reduction. If the CCP parameter is smaller than a pruning threshold, this parameter will be set to zero. In one embodiment, there can be one pruning threshold or multiple pruning thresholds. and the pruning threshold can be a pre-defined value, one of multiple pre-defined values in a lookup table or an implicitly derived value.

In one embodiment, the pruning threshold can be the same for all CCP parameters. In another embodiment, the pruning threshold can be all different or partially different for each CCP parameter. In another embodiment, the pruning threshold can be all different or partially different for each parameter type (e.g., spatial term, gradient term, non-linear term, location term or bias term, etc.)

In one embodiment, some quantization method can be used to reduce the CCP parameter precision.

In one embodiment, the original fixed point CCP parameters can be transformed to floating point datatype, and then further reduce its precision in floating point datatype.

In one embodiment, after the precision reduction, all CCP parameter in one CCP model can have the same bit depth. In another embodiment, after the precision reduction, all CCP parameter in one CCP model can have all different or partially different bit depth.

In one embodiment, the bit depth after precision reduction can depend on the block size. The precision-reduced CCP parameters can have more bit depth if the block size is large. Otherwise, the precision-reduced CCP parameters can have less bit depth if the block size is small.

The CCP information with precision-reduced CCP parameters stored in a buffer can be used in CCP related coding tools. In one embodiment, the spatial candidates of CCP merge mode can inherit the precision-reduced CCP parameters stored in a buffer. In another embodiment, the non-adjacent candidates of CCP merge mode can inherit the precision-reduced CCP parameters stored in a buffer. In another embodiment, the temporal candidates of CCP merge mode can inherit the precision-reduced CCP parameters stored in a buffer. In another embodiment, the CCP information with precision-reduced CCP parameters can be stored in a CCP history list.

### Increasing Precision of Reduced CCP Parameters

Some methods to increase the precision of reduced CCP parameter after inheriting or selected by a CCP related coding tool are disclosed.

The neighbouring information can be used to increase the precision of reduced CCP parameter. In one embodiment, the increased precision can be decided by comparing template matching (TM) cost on neighbouring template region, and the cost calculation method can be SAD or SATD. In another embodiment, the increased precision can be decided by using boundary matching method.

In one embodiment, the neighbouring template region used for precision increase method can be related to the template type in CCP information. For example, if the CCP mode is CCLM_LT, both top and left template can be used.

In one embodiment, all CCP parameter can apply the precision increase method. In one embodiment, only some of the CCP parameter can apply the precision increase method. For example, only the precision of bias term parameter is increased.

### Hiding Neighbouring-Information Based Offset in Bias Term

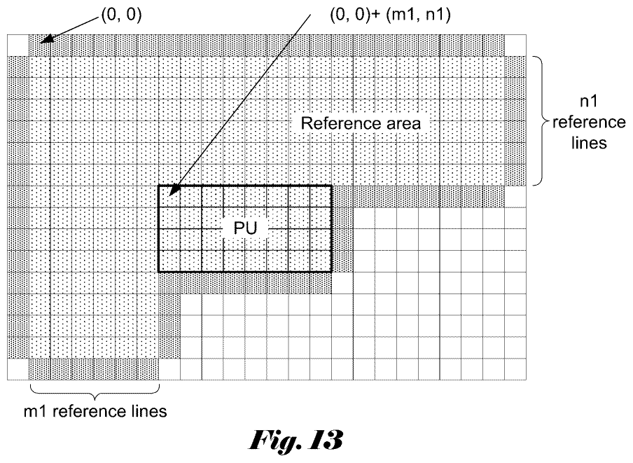

A cross-component model (CCM) can also include information about the neighbouring environment. The neighbouring environmental information can include the values of the neighbouring samples, and/or the neighbouring sample availability, and/or the number of available reference lines. The neighbouring information can be used to derive the offset applied to all or partial terms in the CCM. For example, as described in the Section entitled “Gradient and Location Based Convolutional Cross-Component Model (GL-CCCM)”, the location term X and Y are the horizontal and vertical distance from the top-left corner of the reference area. As depicted in FIG. 13, let the origin (i.e., (0, 0)) of the local coordinates of the current block be at the top-left corner, if the number of available left reference lines and available top reference lines are m1 and n1 respectively, then the local x-y coordinates are offset by m1 and n1 respectively to derive the X and Y value. i.e., the X, Y value of the (0, 0) position of the current block is 0+m1 and 0+n1. For another example, the reference sample values just outside of the top-left corner of the PU are used as the offsets (offsetLuma, offsetCb and offsetCr). The samples values are then offset by these fixed values:

$${C}^{′} = C - offsetLuma , {N}^{′} = N - offsetLuma , {S}^{′} = S - offsetLuma ,$$

$${E}^{′} = E - offsetLuma , {W}^{′} = W - offsetLuma , {P}^{′} = nonLinear ( {C}^{′} ) ,$$

$$B = midValue = 1 << ( bitDepth - 1 ) .$$

When inheriting the model, since the neighbouring information of the current block will not be the same as the inherited block, the neighbouring information needs to be stored. The information can be stored explicitly as part of the CCM. For example, the number of available reference line m1 and n1, and/or the value of offsetLuma, offsetCb, offsetCr can be directly stored. However, this will increase the buffer needed to store the CCM. In this proposal, a method is proposed to hide the offset information in the CCM bias term parameter, so that no additional buffer space is needed to store the neighbouring-information based offset. First, the model parameters are adjusted when storing the CCP model. Second, when the CCP model is inherited, the model parameters are again adjusted. Third, when generating the prediction based on the inherited model, the inherited model is now used in the same way as a derived CCP model, which is derived based on the neighbouring samples of the current block.

Let the general representation of a cross-component model with n input terms be as follows:

$$predChromaVal = {c}_{0} {L}_{0} + {c}_{1} {L}_{1} + {c}_{2} {L}_{2} + … + {c}_{n - 2} {L}_{n - 2} + {c}_{n - 1} B ,$$

where cᵢ is the model parameters, Lᵢ is the value derived from luma samples or other types of input values (e.g., location terms) and B is the offset term. For example, for general CCCM,

$$predChromaVal = {c}_{0} C + {c}_{1} N + {c}_{2} S + {c}_{3} E + {c}_{4} W + {c}_{5} P + {c}_{6} B ,$$

where L₀=C, L₁=N, L₂=S, . . . , and L₅=P.

For another example, for GL-CCCM (as in the Section entitled “Gradient and Location Based Convolutional Cross-Component Model (GL-CCCM)”),

$$predChromaVal = {c}_{0} C + {c}_{1} {G}_{y} + {c}_{2} {G}_{x} + {c}_{3} Y + {c}_{4} X + {c}_{5} P + {c}_{6} B ,$$

where L₀=C, L₁=G_{y}, L₂=Gₓ, . . . , and L₅=P

Let the offset of the i-th term be Oᵢ, Lᵢ=L′ᵢ+Oᵢ, where L′ᵢ is the local value of the current block or the input value before applying the offset. The local value means values derived based the local sample value (luma value, gradient value, . . . ), or/and the local coordinates. Take GL-CCCM (as in the Section entitled “Gradient and Location based Convolutional Cross-Component Model (GL-CCCM)”) as an example,

$$X = {X}^{′} + m 1 , Y = {Y}^{′} + n 1 ,$$

where X′ and Y′ are the local coordinates of the current block, and L′₃=Y′, O₃=n1, and L′4=X′, O₄=m1.

When storing the CCM parameters, instead of explicitly storing Oᵢ, the bias term parameter cₙ₋₁ can be adjusted by cᵢOᵢ/B, the value c_{n-1_stored}=cₙ₋₁+ΣcᵢOᵢ/B is stored as the bias term parameter instead of cₙ₋₁. When the CCM parameters are inherited, assuming the offset of the i-th term of the current blocks is O′ᵢ, O′ᵢ is not necessarily equal to Oᵢ since the offsets are derived based on neighbouring information. The bias term parameter is then re-derived as c_{n-1_derived}=c_{n-1_stored}−ΣcᵢO′ᵢ/B.

Take GL-CCCM (as in the Section entitled “Gradient and Location Based Convolutional Cross-Component Model (GL-CCCM)”) as the example again,

$$\begin{matrix}predChromaVal = {c}_{0} C + {c}_{1} {G}_{y} + {c}_{2} {G}_{x} + {c}_{3} ( {Y}^{′} + n 1 ) + {c}_{4} ( {X}^{′} + m 1 ) + \\ {c}_{5} P + {c}_{6} B \\ = {c}_{0} C + {c}_{1} {G}_{y} + {c}_{2} {G}_{x} + {c}_{3} {Y}^{′} + {c}_{4} {X}^{′} + {c}_{5} P + {c}_{6} B + \\ {c}_{3} n 1 + {c}_{4} m 1 \\ = {c}_{0} C + {c}_{1} {G}_{y} + {c}_{2} {G}_{x} + {c}_{3} {Y}^{′} + {c}_{4} {X}^{′} + {c}_{5} P + \\ ( {c}_{y} + {c}_{3} n 1 / B + {c}_{4} m 1 / B ) B \\ = {c}_{0} C + {c}_{1} {G}_{y} + {c}_{2} {G}_{x} + {c}_{3} {Y}^{′} + {c}_{4} {X}^{′} + {c}_{5} P + {c}_{6 \_ stored} B ,\end{matrix}$$

c_{6_stored}=(c₆+c₃n1/B+c₄m1/B) is then stored in the position of the parameter of the bias term, instead of c₆. When inheriting the CCM model, assuming the number of available left and top reference lines of the current block being u and v respectively, the bias term parameter of the inherited model is then derived as the following:

$$\begin{matrix}predChromaVal = {c}_{0} C + {c}_{1} {G}_{y} + {c}_{2} {G}_{x} + {c}_{3} {Y}^{′} + {c}_{4} {X}^{′} + {c}_{5} P + {c}_{6 \_ stored} B \\ = {c}_{0} C + {c}_{1} {G}_{y} + {c}_{2} {G}_{x} + {c}_{3} ( {Y}^{′} + v ) + {c}_{4} ( {X}^{′} + u ) + {c}_{5} P + \\ {c}_{6 \_ stored} B - {c}_{3} v - {c}_{4} u \\ = {c}_{0} C + {c}_{1} {G}_{y} + {c}_{2} {G}_{x} + {c}_{3} Y + {c}_{4} X + {c}_{5} P + \\ ( {c}_{6 \_ stored} - {c}_{3} v / B - {c}_{4} u / B ) B \\ = {c}_{0} C + {c}_{1} {G}_{y} + {c}_{2} {G}_{x} + {c}_{3} Y + {c}_{4} X + {c}_{5} P + {c}_{5} P + \\ {c}_{6 \_ derived} B\end{matrix}$$

c_{6_derived}=c₆+c₃v/B+c₄u/B is the newly derived bias term parameter. The inherited GL-CCCM model to be applied on the current block is then c₀C+c₁G_{y}+c₂Gₓ+c₃Y+c₄X+c₅P+c₅P+c_{6_derived}B.

In one embodiment, all or partial of the offset terms (e.g., Oi and O′i described in the earlier paragraphs) are determined based on information comprising neighbouring information. The neighbouring information can be, but not limited to, the values of the neighbouring samples, and/or the neighbouring sample availability, and/or the number of available reference lines.

In one sub-embodiment, only the offset terms that are determined solely based on neighbouring information are included in the bias term parameter. The offset terms that are not determined solely based on neighbouring information are stored explicitly as part of the CCM information. When applying the inherited CCM information, the bias term parameter is only adjusted based on the model parameters and offset values associated with offset terms determined solely based on neighbouring information. The input terms associated with offset terms determined solely based on neighbouring information will apply offset derived in the current block, and the input terms associated with offset terms determined not solely based on neighbouring information will apply the inherited offset. For example, assuming a 7-tap cross-component model

$$predChromaVal = {c}_{0} {L}_{0} + {c}_{1} {L}_{1} + {c}_{2} {L}_{2} + … + {c}_{5} {L}_{5} + {c}_{6} B .$$

Assume O₀, O₁, O₂, and O₃ are determined solely based on neighbouring information, and O₄ and O₅ are not determined solely based on neighbouring information (i.e., O′₀, O′₁, O′₂, and O′₃ are determined solely based on neighbouring information, and O′₄ and O′₅ are not determined solely based on neighbouring information). When storing the CCM information, the stored bias term parameter is c_{6_stored}=c₆+Σ_{i<4} cᵢOᵢ/B, and O₄ and O₅ are stored explicitly with the CCM information. When inheriting the CCM information, the bias term parameter is adjusted to c_{6_derived}=c_{6_stored}−Σ_{i<4} cᵢO′ᵢ/B, and O₄ and O₅ are inherited. The prediction of the current block is generated with the following equation:

$$predChromaVal = {c}_{0} ( {L}_{0}^{′} + {O}_{0}^{′} ) + {c}_{1} ( {L}_{1}^{′} + {O}_{1}^{′} ) + {c}_{2} ( {L}_{2}^{′} + {O}_{2}^{′} ) + {c}_{3} ( {L}_{3}^{′} + {O}_{3}^{′} ) + {c}_{4} ( {L}_{4}^{′} + {O}_{4} ) + {c}_{5} ( {L}_{5}^{′} + {O}_{5} ) + {c}_{6 \_ derived} B .$$

In one sub-embodiment, the offset terms can be the reference sample values just outside of the top-left corner of the PU (e.g., offsetLuma, offsetCb and offsetCr).

### Inheriting Partial Model Parameters

For one embodiment, when inheriting the CCM, only partial parameters are inherited (e.g., only n out of 7 filter coefficients of a general CCCM model are inherited, where 1≤n<7), the rest model parameters are further re-derived using the neighbouring luma and chroma samples of the current block.

For another embodiment, when inheriting the CCM, parameters of terms associated with the neighbouring-information based offsets are not inherited. The parameters are derived using the neighbouring luma and chroma reconstruction samples of the current block. For example, when inheriting the GL-CCCM model, only partial model parameters are inherited. For example, only the model parameters, except for the model parameters for the location terms X and Y, are inherited, since location terms X and Y are computed based on the neighbouring information: the number of available left and top reference lines. Then, the model parameters for the location term X and Y are derived using the neighbouring luma and chroma reconstruction samples of the current block. For another example, the neighbouring-information based offsets comprise offsetLuma, offsetCb and offsetCr.

For another embodiment, when inheriting the CCM, bias term parameter and parameters of terms associated with the neighbouring-information based offsets are not inherited. The parameters are derived using the neighbouring luma and chroma reconstruction samples of the current block. For example, when inheriting a GL-CCCM model, only partial model parameters are inherited. The model parameters for the location term X and Y are not inherited, since location terms X and Y are computed based on the neighbouring information: the number of available left and top reference lines. The bias term parameter is also not inherited. Then, the model parameters for the location term X and Y and the bias term parameter are derived using the neighbouring luma and chroma reconstruction samples of the current block. For another example, the neighbouring-information based offsets comprise offsetLuma, offsetCb and offsetCr.

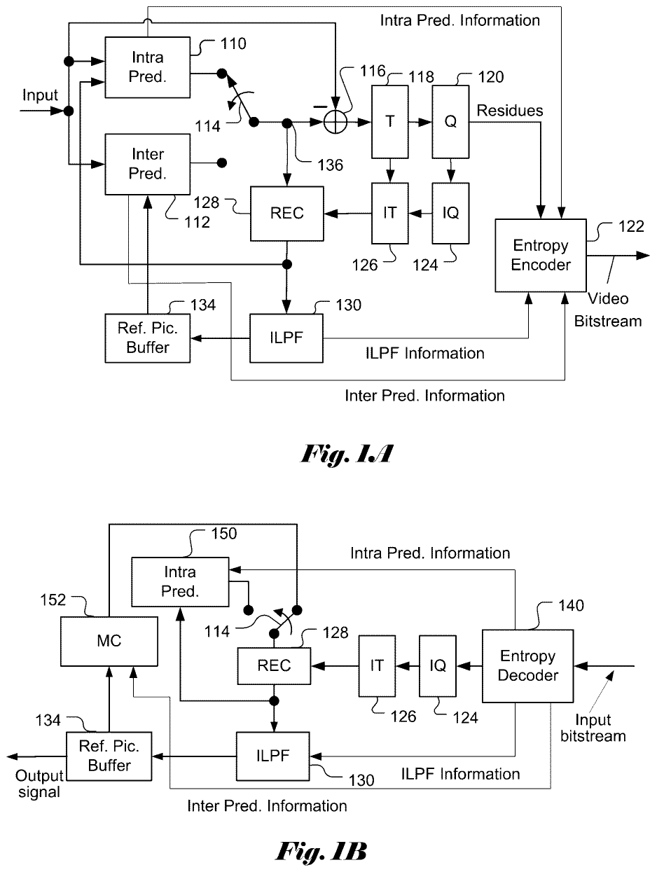

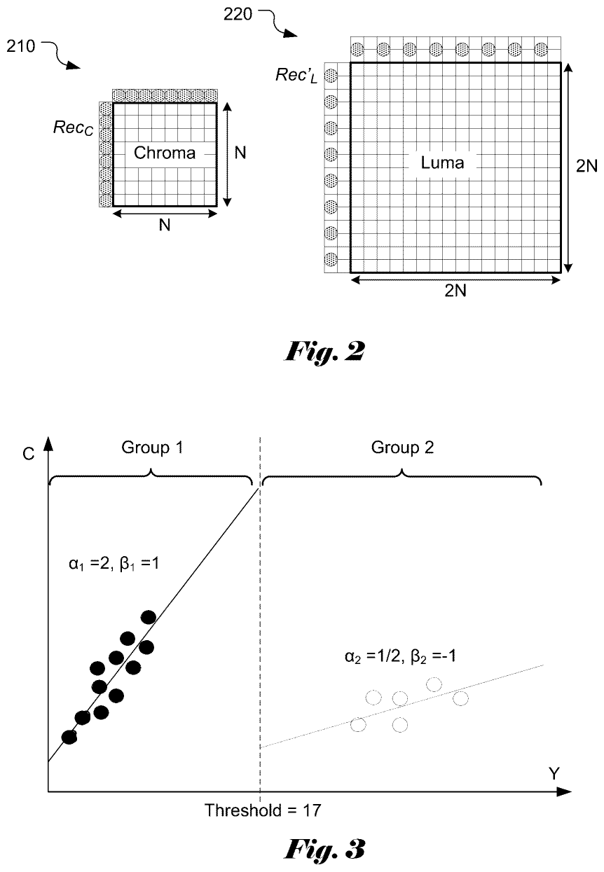

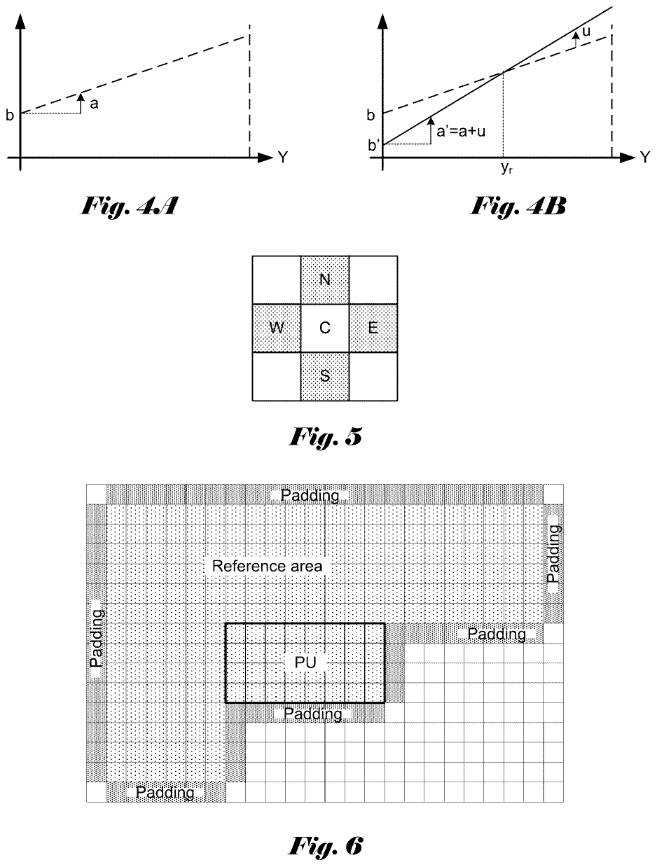

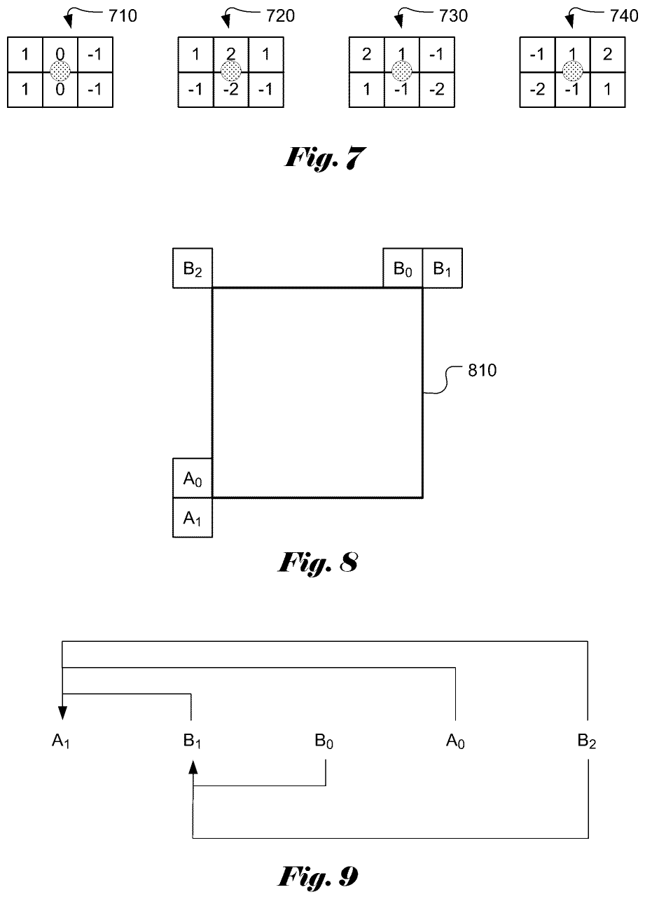

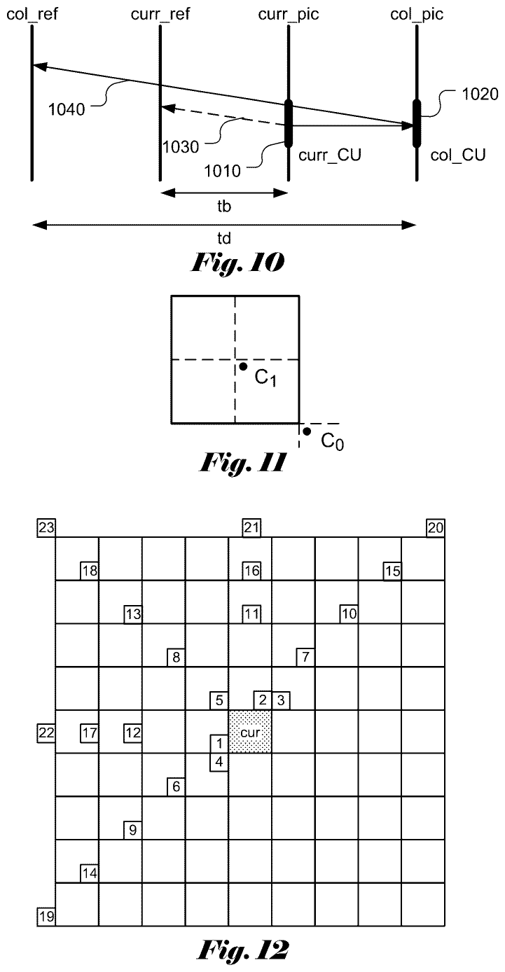

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module. The CCM information inheritance described above can be implemented in an encoder side or a decoder side. For example, any of the proposed CCP methods using an adjusted bias parameter or using a partially inherited CCP candidate can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed CCM information inheritance can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

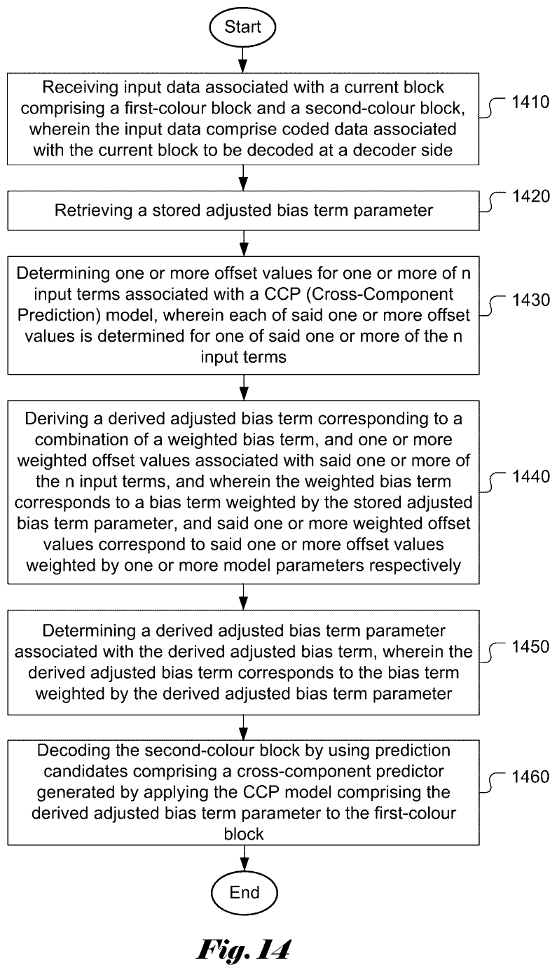

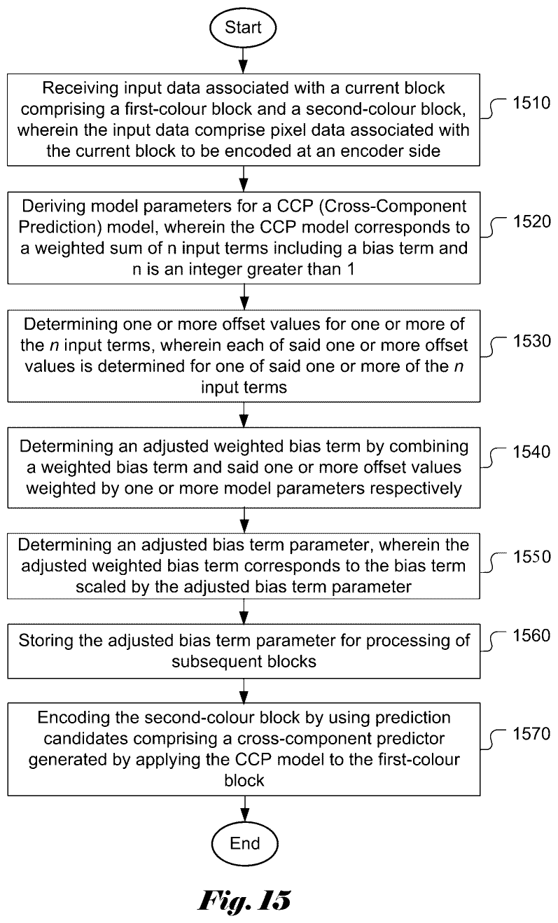

FIG. 14 illustrates a flowchart of an exemplary video decoding system that uses an adjusted bias term parameter according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to one method, input data associated with a current block comprising a first-colour block and a second-colour block are received in step 1410, wherein the input data comprise coded data associated with the current block to be decoded at a decoder side. A stored adjusted bias term parameter is retrieved in step 1420. One or more offset values for one or more of n input terms associated with a CCP (Cross-Component Prediction) model are determined in step 1430, wherein each of said one or more offset values is determined for one of said one or more of the n input terms. A derived adjusted bias term corresponding to a combination of a weighted bias term, and one or more weighted offset values associated with said one or more of the n input terms is derived in step 1440, and wherein the weighted bias term corresponds to a bias term weighted by the stored adjusted bias term parameter, and said one or more weighted offset values correspond to said one or more offset values weighted by one or more model parameters respectively. A derived adjusted bias term parameter associated with the derived adjusted bias term is determined in step 1450, wherein the derived adjusted bias term corresponds to the bias term weighted by the derived adjusted bias term parameter. The second-colour block is decoded by using prediction candidates comprising a cross-component predictor generated by applying the CCP model comprising the derived adjusted bias term parameter to the first-colour block in step 1460.

FIG. 15 illustrates a flowchart of an exemplary video encoding system that uses an adjusted bias term parameter according to an embodiment of the present invention. According to this method, input data associated with a current block comprising a first-colour block and a second-colour block are received in step 1510, wherein the input data comprise pixel data associated with the current block to be encoded at an encoder side. Model parameters for a CCP (Cross-Component Prediction) model are derived in step 1520, wherein the CCP model corresponds to a weighted sum of n input terms including a bias term and n is an integer greater than 1. One or more offset values for one or more of the n input terms are determined in step 1530, wherein each of said one or more offset values is determined for one of said one or more of the n input terms. An adjusted weighted bias term is determined by combining a weighted bias term and said one or more offset values weighted by one or more model parameters respectively in step 1540. An adjusted bias term parameter is determined in step 1550, wherein the adjusted weighted bias term corresponds to the bias term scaled by the adjusted bias term parameter. The adjusted bias term parameter for processing of subsequent blocks is stored in step 1560. The second-colour block is encoded by using prediction candidates comprising a cross-component predictor generated by applying the CCP model to the first-colour block in step 1570.

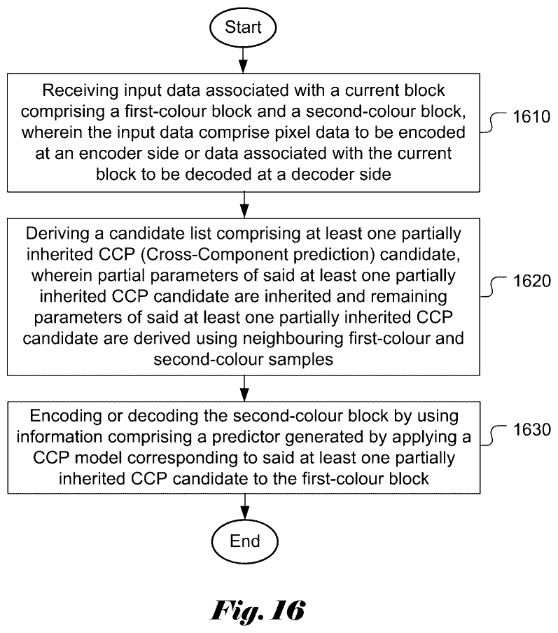

FIG. 16 illustrates a flowchart of an exemplary video coding system that uses a partially inherited Cross-Component Prediction (CCP) candidate according to an embodiment of the present invention. According to this method, input data associated with a current block comprising a first-colour block and a second-colour block are received in step 1610, wherein the input data comprise pixel data to be encoded at an encoder side or data associated with the current block to be decoded at a decoder side. A candidate list comprising at least one partially inherited CCP (Cross-Component prediction) candidate is derived in step 1620, wherein partial parameters of said at least one partially inherited CCP candidate are inherited and remaining parameters of said at least one partially inherited CCP candidate are derived using neighbouring first-colour and second-colour samples. The second-colour block is encoded or decoded by using information comprising a predictor generated by applying a CCP model corresponding to said at least one partially inherited CCP candidate to the first-colour block in step 1630.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of decoding colour pictures using coding tools including one or more cross component models related modes, the method comprising:
receiving input data associated with a current block comprising a first-colour block and a second-colour block, wherein the input data comprise coded data associated with the current block to be decoded at a decoder side;
retrieving a stored adjusted bias term parameter;
determining one or more offset values for one or more of n input terms associated with a CCP (Cross-Component Prediction) model, wherein each of said one or more offset values is determined for one of said one or more of the n input terms;
deriving a derived adjusted bias term corresponding to a combination of a weighted bias term, and one or more weighted offset values associated with said one or more of the n input terms, and wherein the weighted bias term corresponds to a bias term weighted by the stored adjusted bias term parameter, and said one or more weighted offset values correspond to said one or more offset values weighted by one or more model parameters respectively;
determining a derived adjusted bias term parameter associated with the derived adjusted bias term, wherein the derived adjusted bias term corresponds to the bias term weighted by the derived adjusted bias term parameter; and
decoding the second-colour block by using prediction candidates comprising a cross-component predictor generated by applying the CCP model comprising the derived adjusted bias term parameter to the first-colour block.

2. The method of claim 1, wherein the CCP model corresponds to Gradient and Location based Convolutional Cross-Component Model (GL-CCCM).

3. The method of claim 2, wherein said one or more offset values comprise a horizontal offset value and a vertical offset value corresponding to offset values of a top-left location of the current block relative to a top-left location of neighbouring reference area, and wherein the neighbouring reference area is used to derive at least partial information related to the CCP model.

4. The method of claim 1, wherein all or part of said one or more offset values are determined based on information comprising neighbouring information.

5. The method of claim 4, wherein the neighbouring information comprises values of one or more neighbouring samples, availability of said one or more neighbouring samples, a total number of available reference lines, or a combination thereof.

6. The method of claim 4, wherein if a target offset value is derived solely based on the neighbouring information, the target offset value is included in the derived adjusted bias term.

7. The method of claim 4, wherein if a target offset value is not derived solely based on the neighbouring information, the target offset value is stored explicitly.

8. The method of claim 4, wherein said one or more offset values correspond to one or more reference samples just outside a top-left corner of the current block.

9. An apparatus for video decoding, the apparatus comprising one or more electronics or processors arranged to:
receive input data associated with a current block comprising a first-colour block and a second-colour block, wherein the input data comprise coded data associated with the current block to be decoded at a decoder side;
retrieve a stored adjusted bias term parameter;
determine one or more offset values for one or more of n input terms associated with a CCP (Cross-Component Prediction) model, wherein each of said one or more offset values is determined for one of said one or more of the n input terms;
derive a derived adjusted bias term corresponding to a combination of a weighted bias term, and one or more weighted offset values associated with said said one or more of the n input terms, and wherein the weighted bias term corresponds to a bias term weighted by the stored adjusted bias term parameter, and said one or more weighted offset values correspond to said one or more offset values weighted by one or more model parameters respectively;
determine a derived adjusted bias term parameter associated with the derived adjusted bias term, wherein the derived adjusted bias term corresponds to the bias term weighted by the derived adjusted bias term parameter; and
decode the second-colour block by using prediction candidates comprising a cross-component predictor generated by applying the CCP model comprising the derived adjusted bias term parameter to the first-colour block.

10. A method of encoding colour pictures using coding tools including one or more cross component models related modes, the method comprising:
receiving input data associated with a current block comprising a first-colour block and a second-colour block, wherein the input data comprise pixel data associated with the current block to be encoded at an encoder side;
deriving model parameters for a CCP (Cross-Component Prediction) model, wherein the CCP model corresponds to a weighted sum of n input terms including a bias term and n is an integer greater than 1;
determining one or more offset values for one or more of the n input terms, wherein each of said one or more offset values is determined for one of said one or more of the n input terms;
determining an adjusted weighted bias term by combining a weighted bias term and said one or more offset values weighted by one or more model parameters respectively;
determining an adjusted bias term parameter, wherein the adjusted weighted bias term corresponds to the bias term scaled by the adjusted bias term parameter;
storing the adjusted bias term parameter for processing of subsequent blocks; and
encoding the second-colour block by using prediction candidates comprising a cross-component predictor generated by applying the CCP model to the first-colour block.

11. The method of claim 10, wherein the CCP model corresponds to Gradient and Location based Convolutional Cross-Component Model (GL-CCCM).

12. The method of claim 10, wherein said one or more offset values comprise a horizontal offset value and a vertical offset value corresponding to offset values of a top-left location of the current block relative to a top-left location of neighbouring reference area, and wherein the neighbouring reference area is used to derive at least partial information related to the CCP model.

13. An apparatus for video encoding, the apparatus comprising one or more electronics or processors arranged to:
receive input data associated with a current block comprising a first-colour block and a second-colour block, wherein the input data comprise pixel data associated with the current block to be encoded at an encoder side;
derive model parameters for a CCP (Cross-Component Prediction) model, wherein the CCP model corresponds to a weighted sum of n input terms including a bias term and n is an integer greater than 1;
determine one or more offset values for one or more of the n input terms, wherein each of said one or more offset values is determined for one of said one or more of the n input terms;
determine an adjusted weighted bias term by combining a weighted bias term and said one or more offset values weighted by one or more model parameters respectively;
determine an adjusted bias term parameter, wherein the adjusted weighted bias term corresponds to the bias term scaled by the adjusted bias term parameter;
store the adjusted bias term parameter for processing of subsequent blocks; and
encode the second-colour block by using prediction candidates comprising a cross-component predictor generated by applying the CCP model to the first-colour block.

14. A method of coding colour pictures using coding tools including one or more cross component models related modes, the method comprising:
receiving input data associated with a current block comprising a first-colour block and a second-colour block, wherein the input data comprise pixel data to be encoded at an encoder side or data associated with the current block to be decoded at a decoder side;
deriving a candidate list comprising at least one partially inherited CCP (Cross-Component prediction) candidate, wherein partial parameters of said at least one partially inherited CCP candidate are inherited and remaining parameters of said at least one partially inherited CCP candidate are derived using neighbouring first-colour and second-colour samples; and
encoding or decoding the second-colour block by using information comprising a predictor generated by applying a CCP model corresponding to said at least one partially inherited CCP candidate to the first-colour block.

15. The method of claim 14, wherein the CCP model corresponds to Gradient and Location based Convolutional Cross-Component Model (GL-CCCM).

16. The method of claim 15, wherein said one or more offset values comprise a horizontal offset value and a vertical offset value corresponding to offset values of a top-left location of the current block relative to a top-left location of neighbouring reference area, and wherein the neighbouring reference area is used to derive at least partial information related to the CCP model.

17. An apparatus for video coding, the apparatus comprising one or more electronics or processors arranged to:
receive input data associated with a current block comprising a first-colour block and a second-colour block, wherein the input data comprise pixel data to be encoded at an encoder side or data associated with the current block to be decoded at a decoder side;
derive a candidate list comprising at least one partially inherited CCP (Cross-Component prediction) candidate, wherein partial parameters of said at least one partially inherited CCP candidate are inherited and remaining parameters of said at least one partially inherited CCP candidate are derived using neighbouring first-colour and second-colour samples; and
encode or decode the second-colour block by using information comprising a predictor generated by applying a CCP model corresponding to said at least one partially inherited CCP candidate to the first-colour block.
